(19) United States
(12) Patent Application Publication
(10) Pub. No.: US 2026/0087382 A1
(43) Pub. Date: Mar. 26, 2026

(54) MODEL-BASED TASK PROCESSING

(71) Applicant: Beijing Youzhuju Network Technology Co., Ltd., Pinggu District, Beijing (CN)

(72) Inventors: Yu Ting Ko, Hong Kong (HK); Qiushi Huang, Beijing (CN)

(21) Appl. No.: 19/101,805

(22) PCT Filed: Jun. 27, 2024
(86) PCT No.: PCT/CN2024/102125

§ 371 Date: Feb. 6, 2025

(51) Int. Cl. G06N 5/04; G06N 20/00

(52) U.S. Cl. CPC G06N 5/04; G06N 20/00

(57) ABSTRACT

Embodiments of the disclosure provide a solution for model-based task processing. A method includes: obtaining a base parameter set of a pre-trained base machine learning model, and a first parameter set and a second parameter set of a trained low-rank machine learning model for a first task; applying a Hadamard operator on the base parameter set and the first parameter set, to obtain an intermediate parameter set; aggregating the second parameter set and the intermediate parameter set, to obtain an update parameter set; fine-tuning the base parameter set with the update parameter metric, to obtain a fine-tuned parameter set for a target machine learning model corresponding to the first task; and applying the target machine learning model to perform a model inference for the first task with the fine-tuned parameter set.

### FIELD

The disclosed embodiments relate generally to machine learning and, more particularly, to a method, apparatus, device and computer readable storage medium for model-based task processing.

### BACKGROUND

Machine learning models (such as Language Models (LMs)) are capable of performing a wide range of Natural Language Processing (NLP) tasks, including but not limited to question answering, text generation, summarization, translation, and sentiment analysis. Recent advancements in Large Language Models (LLMs) have improved the performance across the various NLP tasks. However, huge parameter sizes of LLMs complicates full fine-tuning under limited computational resources. Consequently, parametric-efficient fine-tuning (PEFT) approaches such as Low-rank Adaptation (LoRA) have become popular to reduce resource demands. There are still some aspects of LoRA that need improvement.

### SUMMARY

In a first aspect of the present disclosure, there is provided a method for model-based task processing. The method comprises: obtaining a base parameter set of a pre-trained base machine learning model, and a first parameter set and a second parameter set of a trained low-rank machine learning model for a first task, the base parameter set, the first parameter set, and the second parameter sets being in a form of matrices with a same dimensionality; applying a Hadamard operator on the base parameter set and the first parameter set, to obtain an intermediate parameter set; aggregating the second parameter set and the intermediate parameter set, to obtain an update parameter set; fine-tuning the base parameter set with the update parameter metric, to obtain a fine-tuned parameter set for a target machine learning model corresponding to the first task; and applying the target machine learning model to perform a model inference for the first task with the fine-tuned parameter set.

In a second aspect of the present disclosure, there is provided an apparatus for model-based task processing. The apparatus comprises: an obtaining module configured to obtain a base parameter set of a pre-trained base machine learning model, and a first parameter set and a second parameter set of a trained low-rank machine learning model for a first task, the base parameter set, the first parameter set, and the second parameter sets being in a form of matrices with a same dimensionality; a first applying module configured to apply a Hadamard operator on the base parameter set and the first parameter set, to obtain an intermediate parameter set; an aggregating module configured to aggregate the second parameter set and the intermediate parameter set to obtain an update parameter set; a fine-tuning module configured to fine-tune the base parameter set with the update parameter metric, to obtain a fine-tuned parameter set for a target machine learning model corresponding to the first task; and a second applying module configured to apply the target machine learning model to perform a model inference for the first task with the fine-tuned parameter set.

In a third aspect of the present disclosure, there is provided an electronic device. The device comprises at least one processing unit; and at least one memory coupled to the at least one processing unit and storing instructions executable by the at least one processing unit. The instructions, upon execution by the at least one processing unit, cause the device to perform the method of the first aspect.

In a fourth aspect of the present disclosure, a computer-readable storage medium is provided. The medium stores a computer program which, when executed by a processor, causes the method of the first aspect to be implemented.

In a fifth aspect of the present disclosure, a computer program product is provided. The computer program product comprises a computer program which, when executed by a processor, causes the method of the first aspect to be implemented.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates an example diagram of a LoRA based process and a high-Rank Adaptation (HiRA) based process in accordance with some embodiments of the present disclosure;

FIG. 3 illustrates a flow chart of a process for model-based task processing in accordance with some embodiments of the present disclosure;

FIG. 4 illustrates a block diagram of an apparatus for model-based task processing according to some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

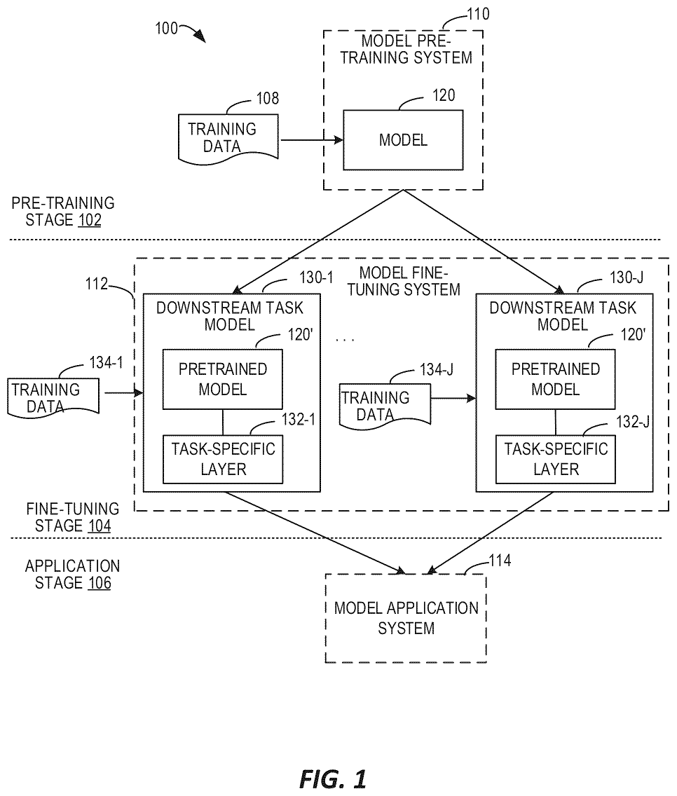

FIG. 1 illustrates a block diagram of an example environment 100 in which various embodiments of the present disclosure can be implemented. In the environment of FIG. 1, three different stages are shown, including a pre-training stage 102, a fine-tuning stage 104, and an application (inference) stage 106. The pre-training stage 102 and a fine-tuning stage 104 may be both considered as model training phases of a model. It is noted that after the pre-training stage or fine-tuning stage is completed, there can also be a test phase (not shown).

In the pre-training stage 102, a pre-training system 110 is configured to pre-train a machine learning model (i.e., a model 120) which can be configured to learn from training data 108 accurate representations of input data (also known as feature representations or features of the input data). Before the pre-training, parameter values of model 120 may be randomly initialized. The pre-training for the model 120 is performed with the training data 108. The parameter values of the model 120 may be updated and adjusted during the pre-training process. After the pre-training, a pre-trained model 120′ may be obtained. At this time, the parameter values of the pre-trained model 120′ have been updated as pre-trained parameter values. In some embodiments, the pre-trained model 120′ may be used as a feature extraction model, which is configured to extract a feature representation of input data.

Through the pre-training stage 102, the model 120 may learn a strong generalization capability from the large scale of training data 108. The pre-trained model 120′ may be provided to a model fine-tuning system 112. The pre-trained model 120′ may be fine-tuned in the model fine-tuning system 112 for one or more downstream tasks. In some example embodiments, for different downstream tasks, the pre-trained model 120′ may be connected to different task-specific layers 132-1, . . . , 132-J (collectively or individually referred to as task-specific layer(s) 132) to build different downstream task models 130-1, . . . , 130-J (collectively or individually referred to as downstream task model(s) 132). This is because different downstream tasks require different outputs. The pre-trained model 120′ may extract a feature representation of a model input and provide it to the task-specific layer 132 to generate an output for the corresponding task.

In the fine-tuning stage 104, according to the requirements of specific downstream tasks, corresponding training data 134-1, . . . , 134-J may be selected to fine tune the built downstream task models 130-1, . . . , 130-J, respectively. The corresponding model training algorithm is also adopted to update and adjust the parameters of the overall model. Since the pre-trained model 120′ has learned a lot from the training data in the pre-training stage, a small amount of training data is needed in the fine-tuning stage 104 to derive a downstream task model that meets the expectation.

In some example embodiments, in the pre-training phase 102, one or more task-specific layers may have been built to pre-train the model 120 for a plurality of downstream tasks according to the requirements of the pre-training objectives. In this case, if a task-specific layer for use in a certain downstream task is the same as the task-specific layer built for the pre-training, the pre-trained model 120′ and the task-specific layer may be directly used to form the corresponding downstream task model. In this case, the downstream task model may not require fine-tuning, or only require fine-tuning of a small amount of training data.

In the application phase 106, the obtained downstream task model may be provided to one or more model application systems 114 for use. In the application phase 106, each downstream task model may be used to process a corresponding input in the practical scenario and provide a corresponding output.

In FIG. 1, the model pre-training system 110, the model fine-tuning system 112, and the model application system 116 may include any computing system or device with the computing capability, such as various computing devices/systems, terminal devices, servers, and the like. Terminal devices may include any type of mobile terminal, fixed terminal or portable terminal, including mobile phone, desktop computer, laptop computer, netbook computer, tablet computer, media computer, multimedia tablet, or any combination thereof, including accessories and peripherals of these devices or any combination thereof. Servers include but are not limited to mainframe, edge computing nodes, computing devices in a cloud environment, and the like.

It would be appreciated that the components and arrangements in the environment 100 shown in FIG. 1 are only examples, and a computing system suitable for implementing the example embodiments described in the present disclosure may include one or more different components, other components, and/or different arrangements. For example, although being illustrated as separate systems, the model pre-training system 110, the model fine-tuning system 112, and the model application system 116 may be integrated in the same system or device. The embodiments of the present disclosure are not limited in this regard. The example embodiments of the model training and model application will be further described with reference to the accompanying figures.

As described above, recent advancements in pre-trained LLMs have enhanced performance across various natural language processing tasks. Traditionally, adapting those LLMs to specific tasks requires full fine tuning, where all the parameters are updated. However, due to the huge number of parameters in those LLMs, full fine-tuning becomes computationally prohibitive, especially under resource constraints.

To address this challenge, it is crucial to adapt LLMs through PEFT, which strives to improve the performance on downstream tasks with minimal updates to parameters. PEFT approaches aim to reduce the requirement for substantial computational resources when adapting LLMs to downstream tasks or language domains. Built on these approaches, parameter updates have introduced to LLMs, maintaining the integrity of the original architecture by freezing their core components. These approaches involve training a small subset of additional parameters as model weights for downstream tasks.

Current PEFT approaches can be divided into three main categories. The first category includes adapter-based approaches. Those approaches insert trainable modules, such as adapter layers, into the original frozen LLMs. Such approaches may add linear layers to LLMs. Adapters may be integrated in parallel for performance enhancement. Those approaches modify the architecture of original models during training and inference, potentially increasing overhead compared to the original LLMs.

The second category comprises prompt-based approaches, which integrate extra trainable virtual tokens into the input of LLMs and focus exclusively on training those tokens. Such approaches may introduce a series of virtual tokens for task-specific adaptations at the initial layer, or add virtual tokens at every layer instead of the initial layer. Although prompt-based approaches add a negligible number of trainable parameters into the input, they are sensitive to initialization. Moreover, due to the quadratic computational complexity of transformer architectures, prompt-based approaches could increase computational costs during inference proportionally to the length of the prompt.

The third category encompasses low-rank adaptation-based approaches. LoRA, as an example of this category, employs a product of two low-rank matrices to approximate the update weight during fine-tuning. This product is seamlessly merged into the original weights without altering a model architecture or incurring additional computational overhead during inference. This technique reduces computational costs required compared to updating a full-rank parameter matrix W. An extended approach, e.g., Weight-Decomposed LowRank Adaptation (DoRA), decomposes the original weight into magnitude and directional components, and then updates the direction component using LoRA. Another extended approach, e.g., Matrix of Rank Adaptation (MoRA), compresses inputs via some predefined functions, then transforms the compressed inputs via a square “higher-rank” matrix, and finally decompresses the matrix to achieve a higher-rank adaptation for LLMs.

However, an inherent low rank of update parameters in LoRA may limit its expressiveness required for adapting to new sub-tasks. Due to the resource constraints, the PEFT strategy still needs to be followed, and, thus, it is difficult to raise the rank of the update parameter matrix to increase its capability.

Some embodiments of the present disclosure, there is provided a solution for model-based task processing. In this solution, a base parameter set of a pre-trained base machine learning model is obtained, and a first parameter set and a second parameter set of a trained low-rank machine learning model are obtained for a first task. The first task may be any type of tasks such as question answering, text generation, summarization, translation, and sentiment analysis. The base parameter set, the first parameter set, and the second parameter sets are in a form of matrices with a same dimensionality. A Hadamard operator is applied on the base parameter set and the first parameter set, to obtain an intermediate parameter set. The second parameter set and the intermediate parameter set are aggregated to obtain an update parameter set. The base parameter set is fine-tuned with the update parameter metric, to obtain a fine-tuned parameter set for a target machine learning model corresponding to the first task. The target machine learning model is applied to perform a model inference for the first task with the fine-tuned parameter set.

With this solution, a Hadamard product may be employed to achieve a higher rank adaptation for LLMs under the PEFT strategy, aiming to enhance the expressiveness of the trainable parameters by increasing the rank of the update weight. Herein, the proposed solution will also be called Hadamard high-Rank Adaptation (HiRA) or an HiRA approach, which may keep update parameters with a high rank, thereby enhancing the model capacity. This solution can easily merge the updated weights into the LLM without complex static compression and decompression functions that can complicate the weight merging into the original LLM.

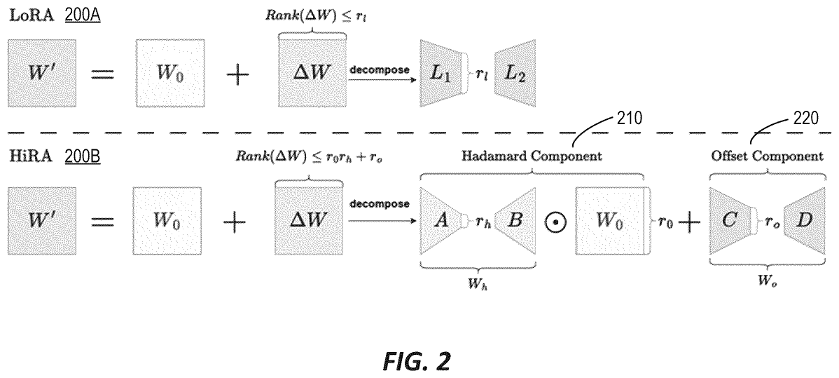

FIG. 2 illustrates an example diagram of a LoRA based process 200A and a HiRA based process 200B in accordance with some embodiments of the present disclosure.

A limitation of LoRA and its variants relying on a product between two low-rank matrices is that the maximum achievable rank of the update parameter is inherently constrained. As shown in FIG. 2, in the LoRA based process 200A, W₀∈ [symbol] denotes an original parameter matrix and its rank is denoted by r₀, where r₀≤min(d, k). LoRA exemplifies PEFT by integrating a low-rank matrix decomposition into an update parameter set, e.g., an update parameter matrix (also referred to as an update matrix) ΔW which is assumed to be a product of L₁∈ [symbol] and L₂∈ [symbol] , i.e., ΔW=L₁L₂. L₂ and L₂ are low-rank matrices, L₁∈ [symbol] and L₂∈ [symbol] , where rₗ is much smaller than d and k, and [symbol] represents a real number set. However, due to the multiplication of low-rank matrices (i.e., L₂ and L₂) in LoRA, the resulting update matrix ΔW, derived from L₁∈ [symbol] and L₂∈ [symbol] , is confined to a maximum rank rₗ. Hence, although ΔW is a d×k matrix, it cannot achieve a larger rank than rₗ, potentially limiting the expressiveness of LoRA and consequently the task adaptation capabilities of LLMs.

Thus, the low-rank property of ΔW may limit its capability to capture high-rank updates. As a result, such low-rank update parameter may limit the rank of the final tuned (or fine-tuned) parameter set (or parameters) denoted by W′ (i.e., W′=W₀+ΔW) since

$$Rank ( {W}_{0} + Δ W ) ⩽ Rank ( {W}_{o} ) + Rank ( Δ W ) ⩽ {r}_{0} + {r}_{l} , \qquad ( 1 )$$

where the first equality holds due to the property of the rank function. Therefore, W′ has a maximum rank of min(min(d, k), r₀+rₗ). Consequently, the low-rank property of ΔW may limit the expressiveness of W′.

To address this, the HiRA based process 200B, as shown in FIG. 2, can learn ΔW with a higher rank under the PEFT strategy, which could enhance expressiveness and performance. In the HiRA based process 200B, a base parameter set of a pre-trained base machine learning model is obtained, e.g., W₀ with a rank indicated by r₀, which may be obtained by a pre-trained base machine learning model during pre-training. In some embodiments, the base machine learning model may be constructed based on a language model. An update parameter set (or update parameters), e.g., ΔW, may be used for fine-tuning of the base parameter set for a specific task. The update parameter set, e.g., ΔW, may comprise two components, including a Hadamard component based on the Hadamard product and an offset component with a low-rank structure.

Built on the Hadamard product, an example formulation for the update parameter matrix as

$$Δ W = R ⊙ {W}_{h} + {W}_{o} , \qquad ( 2 )$$

where ⊙ denotes a Hadamard product, Wₕ and Wₒ are two trainable parameter matrices with ranks rₕ and rₒ, respectively, and R is a matrix without training. In the equation (2), R⊙Wₕ is called the Hadamard component based on the Hadamard product and Wₒ is called the offset component.

In general, the Hadamard product of two matrices P and Q with the same size gives a matrix O satisfying oᵢⱼ=pᵢⱼqᵢⱼ, where pᵢⱼ, qᵢⱼ, and oᵢⱼ denote the (i, j)th entry in P, Q, and O, respectively. The Hadamard product is also known as the elementwise product between two matrices. A nice property of the Hadamard product is that

$$Rank ( P ⊙ Q ) ⩽ Rank ( P ) \times Rank ( Q ) . \qquad ( 3 )$$

According to the inequality (3), it can be seen that the maximal achievable rank of the Hadamard product of two matrices is upper-bounded by the product of their ranks. When P and Q have appropriate sizes to make matrix multiplication feasible,

$$Rank ( PQ ) ⩽ min ( Rank ( P ) , Rank ( Q ) ) . \qquad ( 4 )$$

Compared the inequalities (3) and (4), it can be seen that the upper-bound of the rank of the Hadamard product is much larger than that of the matrix multiplication even when P or Q or both has a low rank. It is to be noted that the update parameter set, e.g., ΔW, in LoRA relies on the matrix multiplication of two low-rank matrices and the inequality (4) implies that the update parameter set in LoRA has a low rank. From the perspective of the upper-bound of the rank, the Hadamard product may help improve the low rank of ΔW in LoRA since the larger upper-bound of the rank may give the larger maximal rank of the Hadamard product.

Based on the inequality (3), the rank of ΔW in the equation (2) is

$$Rank ( Δ W ) ⩽ Rank ( R ) Rank ( {W}_{h} ) + Rank ( {W}_{o} ) . \qquad ( 5 )$$

When R has a large rank, according to the inequality (5), ΔW is expected to have a large rank as the upper-bound of Rank(ΔW) is even larger than min(d, k).

For the choice of R in the equation (2), the base parameter set of the pre-trained base machine learning model, e.g. W₀, may be used as a parameter considering that W₀ could contain useful information about parameters in LLMs. As shown in FIG. 2, the update parameter set, e.g., ΔW, is decomposed into a Hadamard component 210 based on a Hadamard product, e.g., Wₕ⊙W₀, and an offset component 220, e.g, Wₒ, during the fine-tuning.

To obtain such an update parameter set, a first parameter set, e.g., Wₕ, and a second parameter set, e.g., Wₒ, of a trained low-rank machine learning model are obtained for a first task. The first task may be any type of tasks such as question answering, text generation, summarization, translation, and sentiment analysis. The base parameter set (e.g., W₀), the first parameter set (e.g., Wₕ) and the second parameter set (e.g., Wₒ) are in a form of matrices with a same dimensionality.

Then, a Hadamard operator is applied on the base parameter set and the first parameter set, e.g., Wₕ⊙W₀, to obtain an intermediate parameter set. The second parameter set, e.g., Wₒ, and the intermediate parameter set, e.g., Wₕ⊙W₀, are aggregated to obtain the update parameter set, e.g., ΔW. The base parameter set, e.g. W₀, is fine-tuned with the update parameter metric, e.g., ΔW, to obtain a fine-tuned parameter set, e.g., W′, for a target machine learning model corresponding to the first task. The target machine learning model is applied to perform a model inference for the first task with the fine-tuned parameter set.

In some embodiments, a rank of the update parameter set is upper-bounded by a sum of a rank of the base parameter set multiplied by a rank of the first parameter set plus a rank of the second parameter set. For example, the rank of ΔW is upper-bounded by r₀rₕ+rₒ, where r₀, rₕ and rₒ indicate the ranks of W₀, Wₕ and Wₒ. As described above, the rank of ΔW=L₁L₂ in LoRA is upper-bounded by rₗ that indicates the rank of L₁ or L₂. Compared with LoRA, the proposed HiRA approach has the larger maximal rank.

By combining those two components, including the Hadamard component 210 and the offset component 220, in an additive way, the HiRA approach can learn high-rank update parameters with introducing little computational overhead. The proposed HiRA approach may have benefits in various downstream tasks such as commonsense reasoning and conversational tasks.

In some embodiments, the low-rank machine learning model for which the first parameter set and the second parameter set are used may comprise a plurality of low-rank machine learning sub-models, including a low-rank machine learning sub-model (referred to as a first low-rank machine learning sub-model) with the first parameter set, e.g., Wₕ, and a low-rank machine learning sub-model (a second low-rank machine learning sub-model with the second parameter set, e.g., Wₒ.

The first low-rank machine learning sub-model and/or the second low-rank machine learning sub-model may be further divided into different parts. Accordingly, the first parameter set and/or the second parameter set may comprise a plurality of subsets for different parts of the corresponding low-rank machine learning sub-model. For example, the first parameter set may comprise a first parameter matrix (e.g., A in FIG. 2) for a first part of the first low-rank machine learning sub-model and a second parameter matrix (e.g., B in FIG. 2) for a second part of the first low-rank machine learning sub-model. A rank of the first parameter matrix and a rank of the second parameter matrix is lower than a rank of the base parameter set. The second parameter set may comprise a third parameter matrix (e.g., C in FIG. 2) for a first part of the second low-rank machine learning sub-model and a fourth parameter matrix (e.g., D in FIG. 2) for a second part of the second low-rank machine learning sub-model. A rank of the third parameter matrix and a rank of the fourth parameter matrix is lower than a rank of the base parameter set.

By way of example, to achieve the PEFT strategy, Wₕ and Wₒ may be restricted to have low ranks as below:

$${W}_{h} = AB , {W}_{o} = CD , \qquad ( 6 )$$

where A∈ [symbol] , B∈ [symbol] , C∈ [symbol] , and D∈ [symbol] . rₕ and rₒ are much smaller than min(d, k). The two components 210 and 220 may have different ranks, and thus rₕ may be different from rₒ.

According to the decomposition defined in the equation (6), it can be seen that Wₕ is of a maximum rank rₕ, and Wₒ is of a maximum rank rₒ, making both of them have low ranks. By combining all the above considerations together, the update parameter for the proposed HiRA approach can be obtained as

$$Δ W = {W}_{0} ⊙ ( AB ) + CD . \qquad ( 7 )$$

Based on the inequality (5), for ΔW defined in the equation (7), the rank of ΔW is bounded by r₀rₕ+rₒ, which may make its rank become larger, as shown in FIG. 2.

In some embodiments, for a fair comparison with LoRA, the number of trainable parameters in HiRA may be equal to the number of trainable parameters in LoRA. In the example in FIG. 2, LoRA has rₗ(d+k) trainable parameters, while in HiRA, the number of trainable parameters in A, B, C and D equals to (rₕ+rₒ)(d+k). In this event, making rₗ(d+k) equal to (rₕ+rₒ)(d+k) gives a constraint on rₕ and rₒ as

$${c}_{HiRA} = {r}_{h} + {r}_{o} = {r}_{l} , \qquad ( 8 )$$

where c_{HiRA}=rₕ+rₒ is defined as the capacity of HiRA.

During deployment in production, HiRA facilitates efficient inference by precomputing and merging the update parameter set (or the update parameters) into W₀ to form the fine-tuned parameter set W′, e.g., W′=W₀+W₀⊙(AB)+CD. Integrating the update parameters directly into W₀ eliminates computation overhead during inference.

For example, during training, in HiRA, the calculation of Wₕ and Wₒ yields complexities of O(drₕk) and O(drₒk), respectively, leading to a total complexity O(dk(rₕ+rₒ)), which is equal to O(dkrₗ) due to the equation (8). Moreover, the Hadamard product in HiRA introduces a computational overhead of O(dk), and speedup may be enabled through parallel computing techniques. Consequently, the computational complexity of HiRA is at most O(dkrₗ+dk)=O(dkrₗ), which is equal to that of LoRA whose update parameters is a matrix multiplication of two low-rank matrices. Hence, compared to LoRA, HiRA introduces little computational overhead, and during inference such overhead can be effectively neutralized by merging update parameters into LLMs.

Moreover, some other PEFT techniques such as MoRA introduce complex mapping functions to compress the input into a relatively high dimension and then decompress back, which cannot be easily merged into the original parameters in LLMs only if the function mappings in the compression and decompression can be represented by a transformation matrix and will incur additionally computational overhead. HiRA is more beneficial.

In addition, this integrating operation in HiRA also avoids additional latency commonly associated with other PEFT techniques such as Prompt Tuning and P-Tuning.

In some embodiments, the first parameter set, e.g., W₀, may be fixed during the training process of the low-rank machine learning model. For example, during the training process, W₀ remains frozen, while A, B, C and D serve as trainable parameters to facilitate the model updating. For a linear layer h=W₀x, the forward pass of this layer may be modified as

$$h = {W}_{0} x + ( {W}_{0} ⊙ ( AB ) ) x + CDx . \qquad ( 9 )$$

According to the equation (7), it can be seen that when A or B is fixed to be a zero matrix and rₒ is set to be rₗ, ΔW in HiRA becomes ΔW in LoRA. From this perspective, the proposed HiRA may be considered as a generalization of LoRA.

In some embodiments, to obtain the first parameter set, e.g., Wₕ, and the second parameter set, e.g., Wₒ, a training process may be performed on the low-rank machine learning model to obtain the first parameter set and the second parameter set. In some embodiments, the initial value of the update parameter set may be required to be a zero matrix to ensure that the initial value of the update parameter set will not modify the original LLMs. To achieve that, the initial values for Wₕ and Wₒ may be zero matrices. Under this requirement, for example, the first parameter matrix, e.g., A, and the third parameter matrix, e.g., C, may be initialized to be zero matrices, and an initialization process may be performed on the second parameter matrix, e.g., B, and the fourth parameter matrix, e.g., D. It is also possible that B and D (or B and C′) are initialized to be zero matrices and A and C (or A and D) are subject to the initialization process.

In an example, Kaiming initialization may be used. Kaiming Initialization, also called He Initialization, is an initialization process for neural networks that takes into account the non-linearity of activation functions, such as rectified linear unit (ReLU) activations. Any other initialization may be employed, and the present disclosure will not be limited in this regard.

In some embodiments, the base parameter set, e.g., W₀, may be recovered from the fine-tuned parameter set, e.g., W′, based on the first parameter set and the second parameter set. For example, in the case of W′=W₀+W₀⊙(AB)+CD, the original parameter set W₀ in LLMs can be recovered by subtracting CD and then performing elementwise division by AB+1. Then, the LLM can be adapted to new tasks using HiRA, thereby enabling LLMs to switch between tasks swiftly.

In some embodiments, after the base parameter set is recovered, a third parameter set and a fourth parameter set of a further trained low-rank machine learning model may be obtained for a different second task. The second task may be any type of tasks such as question answering, text generation, summarization, translation, and sentiment analysis. The recovered base parameter set, the third parameter set and the fourth parameter sets are in a form of matrices with a same dimensionality. A Hadamard operator may be applied on the recovered base parameter set and the third parameter set, to obtain an intermediate parameter set. The fourth parameter set and the intermediate parameter set may be, to obtain a further update parameter set. The recovered base parameter set may be fine-tuned with the further update parameter metric, to obtain a further fine-tuned parameter set for a further target machine learning model corresponding to the second task. The further target machine learning model may be applied to perform a model inference for the second task with the further fine-tuned parameter set. In this way, efficient model adaptation for inference may be enabled.

Experiments using the commonsense reasoning dataset show that HiRA improves accuracy and performance for commonsense reasoning tasks. Table 1 shows accuracy comparison among various PEFT approaches on commonsense reasoning datasets for Llama-2-7B and Llama-3-8B models and ChatGPT. The best performance within the same LLM is highlighted in underline, while the best performance in all the configurations is shown in bold.

TABLE 1

| Model | Method | Params (%) | Boo1Q | PIQA | SIQA | ARC-c | ARC-Eε | OBQA | HellaS | WinoG | Average |
|---|---|---|---|---|---|---|---|---|---|---|---|
| ChatGPT | — | — | 73.1 | 85.4 | 68.5 | 79.9 | 89.8 | 74.8 | 78.5 | 66.1 | 77.01 |
| Liama-2-7B | Prompt Tuning | 0.0012 | 55.9 | 12.4 | 30.5 | 6.1 | 8.6 | 9.4 | 6.9 | 40.6 | 21.29 |
| | P-Tuning | 07428 | 58.7 | 36.0 | 02 | 0.2 | 2.0 | 0.8 | 0.0 | 0.0 | 12.24 |
| | LoRA | 0.8256 | 69.8 | 79.9 | 79.5 | 64.7 | 79.8 | 81.0 | 83.6 | 82.6 | 77.61 |
| | DoRA | 0.8256 | 71.8 | 83.7 | 76.0 | 68.2 | 83.7 | 82.4 | 89.1 | 82.6 | 79.69 |
| | MoRA | 0.8241 | 72.2 | 80.8 | 79.5 | 71.4 | 85.3 | 81.2 | 29.1 | 80.2 | 72.46 |
| | HiRA (r [symbol] = 2, rₒ = 14) | 0.4128 | 72.4 | 84.8 | 81.4 | 75.3 | 87.8 | 85.2 | 88.8 | 86.6 | 82.79 |
| [symbol] | HiRA (rₕ = 2, rₒ = 30) | 0.8256 | 73.1 | 84.9 | 81.2 | 74.6 | 88.0 | 85.8 | 89.3 | 85.6 | 82.80 |
| Liama-3-8B | Prompt Tuning | 0.0010 | 56.9 | 45.0 | 36.1 | 31.6 | 32.7 | 29.2 | 14.0 | 50.1 | 36.96 |
| | P-Tuning | 0.6240 | 60.0 | 11.6 | 8.2 | 7.4 | 8.6 | 9.6 | 1.8 | 37.6 | 18.11 |
| | LoRA | 0.7002 | 70.8 | 85.2 | 79.9 | 71.2 | 84.2 | 79.0 | 91.7 | 84.3 | 80.79 |
| | DoRA | 0.7002 | 74.6 | 89.3 | 79.9 | 80.4 | 90.5 | 85.8 | 95.5 | 85.6 | 85.20 |
| | MoRA | 0.6997 | 74.3 | 87.4 | 80.7 | 79.6 | 91.2 | 85.6 | 43.5 | 86.7 | 78.63 |
| | HiRA (r [symbol] = 2, rₒ = 14) | 0.3513 | 76.2 | 90.2 | 82.1 | 83.4 | 93.3 | 88.6 | 96.3 | 89.7 | 87.49 |
| | HiRA (rₕ = 4, rₒ = 28) | 0.7002 | 75.1 | 90.1 | 82.2 | 84.6 | 93.9 | 89.6 | 96.2 | 88.2 | 87.50 |

[symbol]

indicates data missing or illegible when filed

As shown in Table 1, HiRA consistently outperforms all baseline approaches in terms of accuracy for both the Llama-2-7B and Llama-3-8B models. For the Llama-2-7B model, HiRA achieves an average accuracy improvement of 3.91% over the best baseline approach (i.e., DoRA). For the Llama-3-8B model, HiRA shows an average performance improvement of 2.70% over DoRA. This underscores the ability of HiRA to effectively utilize the Hadamard product to improve the model capacity and performance. It is to be noted that HiRA with a lower capacity c_{HiRA}=16, using only half a number of trainable parameters compared to LoRA-based baselines, achieves better performance than LoRA and DoRA with rank as 32, which demonstrates the effectiveness of HiRA.

Table 2 shows results on the CONVAI2 Dataset, where BERT F1, BERT-R, and BERT-P denote the F1, Precision, and Recall from BERT score, respectively.

TABLE 2

| Model | Method | BLEU | BLEU-1 | BLEU-2 | BLEU-3 | BLEU-4 | BERT F1 | BERT-R | BERT-P |
|---|---|---|---|---|---|---|---|---|---|
| Liama-3-8B | Prompt Tuning | 1.45 | 12.72 | 2.31 | 0.67 | 0.22 | 82.99 | 82.99 | 83.05 |
| | P-Tuning | 1.50 | 13.50 | 2.46 | 0.69 | 0.22 | 81.52 | 81.07 | 82.01 |
| | MoRA | 1.60 | 15.82 | 2.32 | 0.67 | 0.26 | 84.22 | 84.06 | 84.43 |
| | LoRA | 2.26 | 17.54 | 3.04 | 1.06 | 0.47 | 84.32 | 84.00 | 84.67 |
| | DoRA | 2.29 | 17.41 | 3.03 | 1.07 | 0.49 | 84.32 | 84.06 | 84.62 |
| | HiRA (rₕ = 30, rₒ = 2) | 2.86 | 18.86 | 3.85 | 1.42 | 0.65 | 84.50 | 84.19 | 84.85 |

As shown in Table 2, HiRA outperforms baseline approaches in terms of all the comparison metrics. DoRA and LoRA show comparable performance, whereas MoRA, though not as strong as LoRA in this task, still surpassed both P-Tuning and Prompt-Tuning approaches. Those results further substantiate the effectiveness of HiRA in not only common-sense reasoning but also open-domain generative tasks.

To validate the importance of the two components in HiRA, experiments are conducted on commonsense reasoning tasks by setting either rₕ or rₒ to 0 over Llama-3-8B. Table 3 shows performance comparison among different configurations in HiRA with varying of rₕ and rₒ on commonsense reasoning tasks.

TABLE 3

| HiRA Configuration | Accuracy |
|---|---|
| rₕ = 0, rₒ = 28 | 77.59 |
| rₕ = 0, rₒ = 32 | 79.78 |
| rₕ = 4, rₒ= 0 | 81.26 |
| rₕ = 32, rₒ = 0 | 85.37 |
| rₕ = 4, rₒ = 28 | 87.50 |

As shown in Table 3, the inclusion of the Hadamard component impacts the performance, with configurations with non-zero rₕ's consistently outperforming those with rₕ=0. Specifically, the configuration with rₕ=32 and rₒ=0 yields good performance of 85.37, substantially surpassing that for rₕ=0, rₒ=32 (i.e., 79.78). Even rₕ with a modest value 4 elevates the score to 81.26, which is notably better than the performance 77.59 scored by rₕ=0, rₒ=28. Impressively, a configuration that rₕ=4 and rₒ=28 achieves the best performance 87.50, demonstrating the effectiveness of integrating both the Hadamard and offset components. Those results underscore the crucial role of the Hadamard component in enhancing the model performance, particularly when combined with an appropriate offset component.

The impact of the rank rₕ as well as rₒ to the performance of commonsense reasoning tasks is studied by fixing the capacity of HiRA to be 32 (i.e., rₕ+rₒ=32). HiRA achieves better performance with a smaller rₕ compared to larger rₕ's. One possible reason is that Wₕ with a large rank may lead to the saturation of the rank of W′ due to the property of the Hadamard product (i.e., the inequality (3)). Another possible reason is that as rₕ increases, the rank of Wₒ decreases, which can diminish the expressiveness of the offset component. Hence, in the experiments, a small rₕ (e.g, 2 or 4) is used as the default setting. Despite variations in rₕ, HiRA consistently outperforms DoRA, the strongest baseline approach, and surpasses LoRA.

Further, the impact of different choices of R used in the equation (2) on the performance of commonsense reasoning tasks are explored. Specifically, HiRA is compared with a variant of HiRA (denoted by HiRA_{rand}) that randomly generates R from a uniform distribution [0,1] before the training process and then fixes it. Both approaches follow the same training protocols by utilizing the same optimizer, learning rate, and training epochs.

Table 4 shows performance comparison between different choices of R defined in equation (2). HiRA_{rand} denotes a variant using randomly initialized R instead of W₀.

TABLE 4

| Model | Method | Average |
|---|---|---|
| Llama-3-8B | HiRA (rₕ = 4, r_{d} = 28) | 87.50 |
| | HiRA_{rand} (rₕ = 4, r_{d} = 28) | 41.17 |

As shown in Table 4, HiRA outperforms HiRA_{rand}, which demonstrates the effectiveness of using W₀ as R. Moreover, using W₀ for R may facilitate the recovery of W₀ from the merged parameters W′ when given A, B, C and D), while HiRA_{rand} needs to additionally store R to achieve that, which could incur additional storage costs.

Moreover, the average ranks of the update parameter set ΔW over layers for HiRA, LoRA, and MoRA, which have comparable numbers of trainable parameters, are compared. HiRA possesses ΔW with much higher ranks than LoRA and MoRA, indicating that HiRA can achieve high-rank adaptation under the PEFT strategy via the Hadamard product. It is to be noted that as the layer goes deeper, the rank of ΔW first increases and then fluctuates, which indicates that deeper layers may need a higher-rank ΔW to adapt to new tasks. Overall, HiRA attains higher-rank ΔW across all layers, which correlates with improved performance as detailed in Table 1.

To determine the effort required to optimize the model, the L2 norm of the gradient is tracked throughout the training of HiRA (rₕ=4, rₒ=28) and LoRA (rₗ=32) under an identical training setup. The gradient norm of HiRA is almost lower than that of LoRA, suggesting that HiRA requires less parameter adjustment effort when having the same number of trainable parameters. This demonstrates the efficiency of HiRA in model training, and can suggest better generalization with lower gradient norms.

According to some embodiments of the present disclosure, HiRA, as a high-rank adaptation, maintains comparable numbers of trainable parameters while enhancing the rank of update parameters. HiRA separates the weight into Hadamard and offset components. Additionally, HiRA offers a cost-effective alternative to LoRA, providing similar benefits but without additional inference overhead. Extensive experiments demonstrate the effectiveness of the HiRA approach.

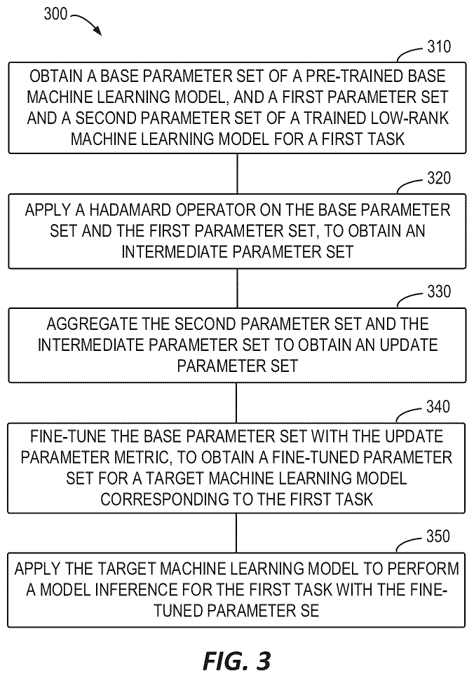

FIG. 3 illustrates a flowchart of a process 300 for model-based task processing in accordance with some embodiments of the present disclosure.

At block 310, a base parameter set of a pre-trained base machine learning model, and a first parameter set and a second parameter set of a trained low-rank machine learning model for a first task are obtained. The base parameter set, the first parameter set, and the second parameter sets are in a form of matrices with a same dimensionality.

At block 320, a Hadamard operator is applied on the base parameter set and the first parameter set, to obtain an intermediate parameter set.

At block 330, the second parameter set and the intermediate parameter set are aggregated to obtain an update parameter set.

At block 340, the base parameter set is fine-tuned with the update parameter metric, to obtain a fine-tuned parameter set for a target machine learning model corresponding to the first task.

At block 350, the target machine learning model is applied to perform a model inference for the first task with the fine-tuned parameter set.

In some embodiments, a rank of the update parameter set may be upper-bounded by a sum of a rank of the base parameter set multiplied by a rank of the first parameter set plus a rank of the second parameter set.

In some embodiments, the low-rank machine learning model may comprise a first low-rank machine learning sub-model with the first parameter set and a second low-rank machine learning sub-model with the second parameter set. The first parameter set may comprise a first parameter matrix for a first part of the first low-rank machine learning sub-model and a second parameter matrix for a second part of the first low-rank machine learning sub-model. A rank of the first parameter matrix and a rank of the second parameter matrix may be lower than a rank of the base parameter set. The second parameter set may comprise a third parameter matrix for a first part of the second low-rank machine learning sub-model and a fourth parameter matrix for a second part of the second low-rank machine learning sub-model. A rank of the third parameter matrix and a rank of the fourth parameter matrix may be lower than a rank of the base parameter set.

In some embodiments, obtaining the first parameter set and the second parameter set may comprise: performing a training process on the low-rank machine learning model to obtain the first parameter set and the second parameter set by: initializing the first parameter matrix and the third parameter matrix to be zero matrices; and performing an initialization process on the second parameter matrix and the fourth parameter matrix.

In some embodiments, the first parameter set may be fixed during the training process of the low-rank machine learning model.

In some embodiments, the process 300 may further comprise: recovering the base parameter set from the fine-tuned parameter set based on the first parameter set and the second parameter set.

In some embodiments, the process 300 may further comprise: obtaining a third parameter set and a fourth parameter set of a further trained low-rank machine learning model for a second task, the recovered base parameter set, the third parameter set and the fourth parameter sets being in a form of matrices with a same dimensionality; applying a Hadamard operator on the recovered base parameter set and the third parameter set, to obtain an intermediate parameter set; aggregating the fourth parameter set and the intermediate parameter set, to obtain a further update parameter set; fine-tuning the recovered base parameter set with the further update parameter metric, to obtain a further fine-tuned parameter set for a further target machine learning model corresponding to the second task; and applying the further target machine learning model to perform a model inference for the second task with the further fine-tuned parameter set.

In some embodiments, the base machine learning model may be constructed based on a language model.

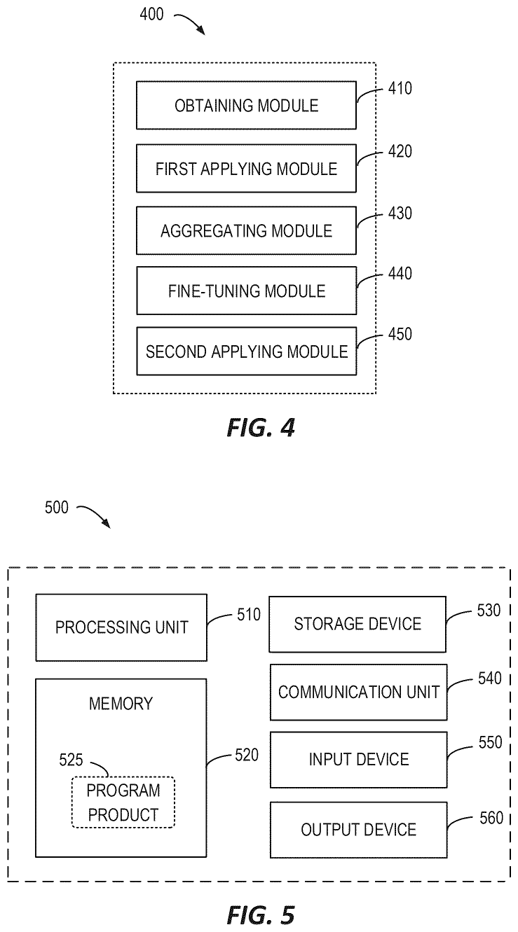

FIG. 4 shows a block diagram of an apparatus 400 for model-based task processing in accordance with some embodiments of the present disclosure. Various modules/components in the apparatus 400 may be implemented by hardware, software, firmware, or any combination thereof.

As shown in FIG. 4, the apparatus 400 includes an obtaining module 410 configured to obtain a base parameter set of a pre-trained base machine learning model, and a first parameter set and a second parameter set of a trained low-rank machine learning model for a first task. The base parameter set, the first parameter set, and the second parameter sets are in a form of matrices with a same dimensionality.

The apparatus 400 further includes a first applying module 420 configured to apply a Hadamard operator on the base parameter set and the first parameter set, to obtain an intermediate parameter set; an aggregating module 430 configured to aggregate the second parameter set and the intermediate parameter set to obtain an update parameter set; a fine-tuning module 440 configured to fine-tune the base parameter set with the update parameter metric, to obtain a fine-tuned parameter set for a target machine learning model corresponding to the first task; and a second applying module 450 configured to apply the target machine learning model to perform a model inference for the first task with the fine-tuned parameter set.

In some embodiments, a rank of the update parameter set may be upper-bounded by a sum of a rank of the base parameter set multiplied by a rank of the first parameter set plus a rank of the second parameter set.

In some embodiments, the low-rank machine learning model may comprise a first low-rank machine learning sub-model with the first parameter set and a second low-rank machine learning sub-model with the second parameter set. The first parameter set may comprise a first parameter matrix for a first part of the first low-rank machine learning sub-model and a second parameter matrix for a second part of the first low-rank machine learning sub-model. A rank of the first parameter matrix and a rank of the second parameter matrix may be lower than a rank of the base parameter set. The second parameter set may comprise a third parameter matrix for a first part of the second low-rank machine learning sub-model and a fourth parameter matrix for a second part of the second low-rank machine learning sub-model. A rank of the third parameter matrix and a rank of the fourth parameter matrix may be lower than a rank of the base parameter set.

In some embodiments, the obtaining module 410 may be configured to perform a training process on the low-rank machine learning model to obtain the first parameter set and the second parameter set by: initializing the first parameter matrix and the third parameter matrix to be zero matrices; and performing an initialization process on the second parameter matrix and the fourth parameter matrix.

In some embodiments, the first parameter set may be fixed during the training process of the low-rank machine learning model.

In some embodiments, the apparatus 400 may further comprise: a recovering module configured to recover the base parameter set from the fine-tuned parameter set based on the first parameter set and the second parameter set.

In some embodiments, the obtaining module 410 may be further configured to obtain a third parameter set and a fourth parameter set of a further trained low-rank machine learning model for a second task. The recovered base parameter set, the third parameter set and the fourth parameter sets are in a form of matrices with a same dimensionality. The first applying module 420 may be further configured to apply a Hadamard operator on the recovered base parameter set and the third parameter set, to obtain an intermediate parameter set. The aggregating module 430 may be further configured to aggregate the fourth parameter set and the intermediate parameter set, to obtain a further update parameter set. The fine-tuning module 440 may be further configured to fine-tune the recovered base parameter set with the further update parameter metric, to obtain a further fine-tuned parameter set for a further target machine learning model corresponding to the second task. The second applying module 450 may be further configured to apply the further target machine learning model to perform a model inference for the second task with the further fine-tuned parameter set.

In some embodiments, the base machine learning model may be constructed based on a language model.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the process 300 in FIG. 3. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method for model-based task processing, comprising:
obtaining a base parameter set of a pre-trained base machine learning model, and a first parameter set and a second parameter set of a trained low-rank machine learning model for a first task, the base parameter set, the first parameter set and the second parameter sets being in a form of matrices with a same dimensionality;
applying a Hadamard operator on the base parameter set and the first parameter set, to obtain an intermediate parameter set;
aggregating the second parameter set and the intermediate parameter set, to obtain an update parameter set;
fine-tuning the base parameter set with the update parameter metric, to obtain a fine-tuned parameter set for a target machine learning model corresponding to the first task; and
applying the target machine learning model to perform a model inference for the first task with the fine-tuned parameter set.

2. The method of claim 1, wherein a rank of the update parameter set is upper-bounded by a sum of a rank of the base parameter set multiplied by a rank of the first parameter set plus a rank of the second parameter set.

3. The method of claim 1, wherein the low-rank machine learning model comprises a first low-rank machine learning sub-model with the first parameter set and a second low-rank machine learning sub-model with the second parameter set,
wherein the first parameter set comprises a first parameter matrix for a first part of the first low-rank machine learning sub-model and a second parameter matrix for a second part of the first low-rank machine learning sub-model, a rank of the first parameter matrix and a rank of the second parameter matrix being lower than a rank of the base parameter set; and
wherein the second parameter set comprises a third parameter matrix for a first part of the second low-rank machine learning sub-model and a fourth parameter matrix for a second part of the second low-rank machine learning sub-model, a rank of the third parameter matrix and a rank of the fourth parameter matrix being lower than a rank of the base parameter set.

4. The method of claim 3, wherein obtaining the first parameter set and the second parameter set comprises:
performing a training process on the low-rank machine learning model to obtain the first parameter set and the second parameter set by:
initializing the first parameter matrix and the third parameter matrix to be zero matrices; and
performing an initialization process on the second parameter matrix and the fourth parameter matrix.

5. The method of claim 4, wherein the first parameter set is fixed during the training process of the low-rank machine learning model.

6. The method of claim 1, further comprising:
recovering the base parameter set from the fine-tuned parameter set based on the first parameter set and the second parameter set.

7. The method of claim 6, further comprising:
obtaining a third parameter set and a fourth parameter set of a further trained low-rank machine learning model for a second task, the recovered base parameter set, the third parameter set and the fourth parameter sets being in a form of matrices with a same dimensionality;
applying a Hadamard operator on the recovered base parameter set and the third parameter set, to obtain an intermediate parameter set;
aggregating the fourth parameter set and the intermediate parameter set, to obtain a further update parameter set;
fine-tuning the recovered base parameter set with the further update parameter metric, to obtain a further fine-tuned parameter set for a further target machine learning model corresponding to the second task; and
applying the further target machine learning model to perform a model inference for the second task with the further fine-tuned parameter set.

8. The method of claim 1, wherein the base machine learning model is constructed based on a language model.

9-12. (canceled)

13. An electronic device, comprising:
at least one processor; and
at least one memory coupled to the at least one processor and storing instructions executable by the at least one processor, the instructions, upon execution by the at least one processor, causing the device to perform acts comprising:
obtaining a base parameter set of a pre-trained base machine learning model, and a first parameter set and a second parameter set of a trained low-rank machine learning model for a first task, the base parameter set, the first parameter set and the second parameter sets being in a form of matrices with a same dimensionality;
applying a Hadamard operator on the base parameter set and the first parameter set, to obtain an intermediate parameter set;
aggregating the second parameter set and the intermediate parameter set, to obtain an update parameter set;
fine-tuning the base parameter set with the update parameter metric, to obtain a fine-tuned parameter set for a target machine learning model corresponding to the first task; and
applying the target machine learning model to perform a model inference for the first task with the fine-tuned parameter set.

14. The electronic device of claim 13, wherein a rank of the update parameter set is upper-bounded by a sum of a rank of the base parameter set multiplied by a rank of the first parameter set plus a rank of the second parameter set.

15. The electronic device of claim 13, wherein the low-rank machine learning model comprises a first low-rank machine learning sub-model with the first parameter set and a second low-rank machine learning sub-model with the second parameter set,
wherein the first parameter set comprises a first parameter matrix for a first part of the first low-rank machine learning sub-model and a second parameter matrix for a second part of the first low-rank machine learning sub-model, a rank of the first parameter matrix and a rank of the second parameter matrix being lower than a rank of the base parameter set; and
wherein the second parameter set comprises a third parameter matrix for a first part of the second low-rank machine learning sub-model and a fourth parameter matrix for a second part of the second low-rank machine learning sub-model, a rank of the third parameter matrix and a rank of the fourth parameter matrix being lower than a rank of the base parameter set.

16. The electronic device of claim 15, wherein obtaining the first parameter set and the second parameter set comprises:
performing a training process on the low-rank machine learning model to obtain the first parameter set and the second parameter set by:
initializing the first parameter matrix and the third parameter matrix to be zero matrices; and
performing an initialization process on the second parameter matrix and the fourth parameter matrix.

17. The electronic device of claim 16, wherein the first parameter set is fixed during the training process of the low-rank machine learning model.

18. The electronic device of claim 13, wherein the acts further comprise:
recovering the base parameter set from the fine-tuned parameter set based on the first parameter set and the second parameter set.

19. The electronic device of claim 18, wherein the acts further comprise:
obtaining a third parameter set and a fourth parameter set of a further trained low-rank machine learning model for a second task, the recovered base parameter set, the third parameter set and the fourth parameter sets being in a form of matrices with a same dimensionality;
applying a Hadamard operator on the recovered base parameter set and the third parameter set, to obtain an intermediate parameter set;
aggregating the fourth parameter set and the intermediate parameter set, to obtain a further update parameter set;
fine-tuning the recovered base parameter set with the further update parameter metric, to obtain a further fine-tuned parameter set for a further target machine learning model corresponding to the second task; and
applying the further target machine learning model to perform a model inference for the second task with the further fine-tuned parameter set.

20. The electronic device of claim 1, wherein the base machine learning model is constructed based on a language model.

21. A non-transitory computer-readable storage medium having a computer program stored thereon, the computer program, upon execution by a device, causing the device to perform acts comprising:
obtaining a base parameter set of a pre-trained base machine learning model, and a first parameter set and a second parameter set of a trained low-rank machine learning model for a first task, the base parameter set, the first parameter set and the second parameter sets being in a form of matrices with a same dimensionality;
applying a Hadamard operator on the base parameter set and the first parameter set, to obtain an intermediate parameter set;
aggregating the second parameter set and the intermediate parameter set, to obtain an update parameter set;
fine-tuning the base parameter set with the update parameter metric, to obtain a fine-tuned parameter set for a target machine learning model corresponding to the first task; and
applying the target machine learning model to perform a model inference for the first task with the fine-tuned parameter set.

22. The non-transitory computer-readable storage medium of claim 21, wherein a rank of the update parameter set is upper-bounded by a sum of a rank of the base parameter set multiplied by a rank of the first parameter set plus a rank of the second parameter set.

23. The non-transitory computer-readable storage medium of claim 21, wherein the low-rank machine learning model comprises a first low-rank machine learning sub-model with the first parameter set and a second low-rank machine learning sub-model with the second parameter set,
wherein the first parameter set comprises a first parameter matrix for a first part of the first low-rank machine learning sub-model and a second parameter matrix for a second part of the first low-rank machine learning sub-model, a rank of the first parameter matrix and a rank of the second parameter matrix being lower than a rank of the base parameter set; and
wherein the second parameter set comprises a third parameter matrix for a first part of the second low-rank machine learning sub-model and a fourth parameter matrix for a second part of the second low-rank machine learning sub-model, a rank of the third parameter matrix and a rank of the fourth parameter matrix being lower than a rank of the base parameter set.

24. The non-transitory computer-readable storage medium of claim 23, wherein obtaining the first parameter set and the second parameter set comprises:
performing a training process on the low-rank machine learning model to obtain the first parameter set and the second parameter set by:
initializing the first parameter matrix and the third parameter matrix to be zero matrices; and
performing an initialization process on the second parameter matrix and the fourth parameter matrix.
